(19) United States
(12) Patent Application Publication
(10) Pub. No.: US 2008/0312812 A1
(43) Pub. Date: Dec. 18, 2008

(54) SUSPENSION HEIGHT CONTROL ALLOWING FOR DETERMINATION OF VEHICLE CENTER OF GRAVITY

(75) Inventors: Patrick J. Fitzgibbons, Owego, NY (US); Rachael M. Karl, Owego, NY (US)

Correspondence Address: BURNS & LEVINSON, LLP, 125 SUMMER STREET, BOSTON, MA, 02110, US

(73) Assignee: Lockheed Martin Corporation, Bethesda, MD (US)

(21) Appl. No.: 11/761,648

(22) Filed: Jun. 12, 2007

(51) Int. Cl. G06F 17/00; G06F 17/11

(52) U.S. Cl. 701/124

(57) ABSTRACT

A process for determining a center of gravity of a vehicle having a sprung portion and an unsprung portion on the basis of selective variation of a lateral and a longitudinal orientation of the sprung portion relative to the unsprung portion.

### STATEMENT REGARDING FEDERALLY SPONSORED RESEARCH OF DEVELOPMENT

This invention was made and funded in part by the U.S. Government, specifically by the U.S. Army Tank-Automotive & Armaments Co. under Contract W56HZV-05-9-0002. The U.S. Government has certain rights in the invention.

### FIELD OF THE INVENTION

The present invention relates generally to the field of vehicles, and, more particularly, to determination of the center of gravity of the vehicle.

### BACKGROUND OF THE INVENTION

A loaded vehicle traveling over sloping terrain is susceptible to turning over, creating a hazard for the vehicle, the vehicle load, and the operating personnel. Problems arise, even on level terrain, when loads may become asymmetric or when the vehicle acquires a side-to-side swaying motion.

If the location of the center of gravity of a loaded vehicle were available to an active stability control system and/or a roll over warning system, measures might be taken to preserve the vehicle stability. When road conditions and driving operations cause vehicle orientation to approach the boundary of stable operation beyond which the center of gravity of the loaded vehicle falls outside of the perimeter associated with the wheelbase and the track of the vehicle, the vehicle light he slowed or the turning angle reduced to prevent the vehicle from tipping over.

Although the location of the center of gravity of the vehicle when empty may be known, the center of gravity of a vehicle holding cargo is generally unknown. Moreover, being dependent on the configuration of the vehicle, for example, on the amount and distribution of fuel, cargo, and passengers, the center of gravity often changes. As cargo is loaded onto vehicle, it would be helpful to know the vehicle center of gravity on an ongoing basis. Knowing the center of gravity of the vehicle and the weight per axle is valued information to those individuals responsible for loading the vehicles onto other means of transportation. Such information would allow those loading the vehicle to adjust the load to assure that the center of gravity remains within the range specified by the manufacturer of the vehicle during vehicle travel over expected terrain at anticipated speeds, thereby assuring safe operation of the vehicle. The real time output of the center of gravity of the loaded vehicle could be used to allow those loading the vehicle to adjust the load to assure that the center of gravity is within the manufacturer's specified range to assure safe operation of the vehicle. If the vehicle is also equipped with an active stability control system and/or a roll-over warning system, the true center of gravity would be an important input into those systems.

What is needed is a method and system for determining the center of gravity of a vehicle quickly and accurately in the field when the vehicle is carrying cargo and is resting on level or on non-level terrain. Information regarding the location of the center of gravity may be used to guide loading of the vehicle in anticipation of expected terrain.

### SUMMARY OF THE INVENTION

The needs of the invention set forth above as well as further and other needs and advantages of the present invention are achieved by the embodiments of the invention described herein below.

According to one aspect of die invention, a method for determining a center of gravity of a vehicle having a sprung portion and an unsprung portion includes determining at least one unraised tilt angle by determining an unraised longitudinal tilt angle and an unraised lateral tilt angle, determining at least one unraised sprung weight determining an unraised longitudinal sprung weight and an unraised lateral sprung weight, raising a side of the sprung portion, determining a raised tilt angle, determining a raised sprung weight, lowering the side of the sprung portion, raising another side of the sprung portion, determining another raised tilt angle, determining another raised sprung weight, lowering the other side of the vehicle, determining a sprung portion center of gravity position, and determining the vehicle center of gravity position based upon the above determinations.

In certain embodiments according to the present invention, determining an unraised longitudinal tilt angle may include determining a terrain-induced front-to-back tilt angle and determining an unraised lateral tilt angle may include determining a terrain-induced right-to-left tilt angle.

In other embodiments according to the present invention, determining an unraised longitudinal sprung weight and an unraised lateral sprung weight may include determining a terrain-induced sprung weight over a rear-left wheel, determining a terrain-induced sprung weight over a rear-right wheel, determining the unraised longitudinal sprung weight by summing the terrain-induced sprung weight over a rear-left wheel and the terrain-induced sprung weight over a rear-right wheel, determining a terrain-induced sprung weight over a front-left wheel, and determining the unraised lateral sprung weight by summing the terrain-induced sprung weight over a front-left wheel and the terrain-induced sprung weight over a rear-left wheel.

In further embodiments according to the present invention, raising a side of the sprung portion may include raising a longitudinal side of the sprung portion and determining a raised tilt angle may include determining a raised longitudinal tilt angle. Raising a longitudinal side of the sprung portion may include expanding a rear-left wheel adjustable support and a rear-right adjustable support. Determining a raised longitudinal tilt angle may include measuring a raised front-to-rear tilt angle. Determining a raised longitudinal tilt angle may include determining a height of an adjustable support, the adjustable support being at a lateral position, determining a height of another adjustable support, the other adjustable support being at the lateral position, and determining the raised longitudinal tilt angle as a difference between the height of the adjustable support and the height of the other adjustable support divided by a wheel base of the vehicle. The adjustable support may be at a maximum expansion and the other adjustable support may be at a minimum expansion.

Determining a raised sprung weight may include determining a raised longitudinal sprung weight. Determining a raised sprung weight may include determining a raised-sprung weight over a rear-left wheel, determining a raised-sprung weight over a rear-right wheel, and determining the longitudinal raised sprung weight as the sum of the raised-sprung weight over the rear-left wheel and the raised-sprung weight over the rear-right wheel.

In additional embodiments according to the present invention, raising another side of the vehicle may include raising a lateral side of the vehicle and determining another raised tilt angle may include determining a raised lateral tilt angle. Raising the lateral side of the vehicle may include expanding a front-left wheel adjustable support and a rear left-wheel adjustable support. Determining a raised lateral tilt angle may include measuring a raised left-to-right tilt angle. Determining a raised lateral tilt angle may include determining a height of an adjustable support, the adjustable support being at a longitudinal position, determining a height of another adjustable support, the other front adjustable support being at the longitudinal position, and determining the raised lateral tilt angle as a difference between the height of the adjustable support and the height of the other adjustable support divided by a wheel base of the vehicle. The adjustable support may be at a maximum expansion and the other adjustable support may be at a minimum expansion.

Determining another raised sprung weight may include determining a raised lateral sprung weight. Determining a raised lateral sprung weight may include determining a raised-sprung weight over a front-left wheel, determining a raised-sprung weight over a rear-left wheel, and determining the raised lateral sprung weight as the sum of the raised-sprung weight over the front-left wheel and the raised-sprung weight over the rear-left wheel.

In still further embodiments according to the present invention, determining a sprung portion center of gravity position may include determining a lateral angle of a sprung portion center of gravity relative to a line connecting a center of a front-right wheel and a center of a rear-right wheel, determining a lateral position of the sprung portion center of gravity relative to the line connecting the center of the front-right wheel and the center of the rear-right wheel, determining a longitudinal angle of the sprung portion center of gravity perpendicular to the line connecting the center of a front-left wheel and center of the front-right wheel, determining a longitudinal position of the sprung portion center of gravity perpendicular to the line connecting the center of the front-left wheel and the center of the front-right wheel, and determining a height of the sprung portion center of gravity relative to the sprung portion.

Determining a longitudinal angle of a sprung portion center of gravity perpendicular to the line connecting the center of the front-left wheel and center of the front-right wheel may include evaluating

A′=tan⁻¹(((B₁)(cos β′)−(B₂)(cos α′))/((B₁)(sin β′)−(B₂)(sin α′)));

wherein A′ is the longitudinal angle of the sprung portion center of gravity, B₁ is an unraised longitudinal sprung weight, B₂ is a raised longitudinal sprung weight, α′ is an unraised longitudinal tilt angle, and β′ is a raised longitudinal tilt angle. Determining a longitudinal position of the sprung portion center of gravity perpendicular to the line connecting the center of the front-left wheel and the center of the front-right wheel may include evaluating

Y_{S}=((B₁)(WB)(cos A′))/((W_{S})(cos (A′+α′)));

wherein Y_{S} is the longitudinal position of the sprung portion center of gravity perpendicular to the line connecting the center of the front-left wheel and the center of the front-right wheel, WB is the wheelbase of the vehicle, and W_{S} is the sprung weight of the vehicle. Determining the height of the sprung portion center of gravity relative to the unsprung portion may include evaluating

H_{S}=(Y_{S})(tan A′);

wherein H_{S} is the height of the sprung portion center of gravity relative to a plane of the unsprung portion, said plane of the unsprung portion including wheel centers. Determining a lateral angle of a sprung portion center of gravity relative to a line connecting a center of the front-right wheel and a center of the rear-right wheel may include evaluating

A=tan⁻¹(((L₁i)(cos β)−(L₂)(cos α))/((L₁)(sin β)−(L₂)(sin α)));

wherein A is a lateral angle of the sprung portion center of gravity relative to a line connecting a center of the front-right wheel and a center of the rear-right wheel, L₁ is an unraised lateral sprung weight, L₂ is an raised lateral sprung weight, α is an unraised lateral tilt angle, and β is a raised lateral tilt angle. Determining a lateral position of the sprung portion center of gravity relative to the line connecting the center of the front-right wheel and the center of the rear-right wheel may include evaluating

X_{S}=((L₁)(T)(cos A))/((W_{S})(cos(A+α)));

wherein X_{S} is the lateral position of the sprung portion center of gravity relative to the line connecting the center of the front-right wheel and the center of the rear-right wheel, T is the track width of the vehicle, and W_{S} is the sprung weight of the vehicle.

In still additional embodiments according to the present invention, determining the vehicle center of gravity position may include determining a lateral position of the vehicle center of gravity relative to the line connecting the center of a front-right wheel and the center of a rear-right wheel, determining a longitudinal position of the vehicle center of gravity perpendicular to the line connecting the center of a front-left wheel and the center of the front-right wheel, and determining a height of the vehicle center of gravity relative to a terrain.

Determining a lateral position of the vehicle center of gravity relative to the line connecting the center of the front-right wheel and the center of the rear-right wheel may include evaluating

X_{T}=((W_{S})(X_{S})+(W_{U})(T/2))/(W_{T});

wherein X_{T} is the lateral position of the vehicle center of gravity relative to the line connecting the center of the front-right wheel and the center of the rear-right wheel, W_{S} is a total sprung weight, X_{S} is a lateral position of the sprung portion center of gravity relative to the line connecting the center of the front-right wheel and the center of the rear-tight wheel, W_{U} is a weight of the unsprung portion, T is a track width, and W_{T} is the total weight of the vehicle, the sum of W_{S} and W_{U}. Determining a longitudinal position of the vehicle center of gravity perpendicular to the line connecting the center of the front-left wheel and the center of the front-right wheel may include evaluating

Y_{T}=((W_{S})(Y_{S})+(W_{U})(WB/2))/(W_{T});

wherein Y_{T} is the longitudinal position of the vehicle center of gravity perpendicular to the line connecting the center of the front-left wheel and the center of the front-right wheel, Y_{S} is a longitudinal position of the sprung portion center of gravity relative to the line connecting the center of the front-left wheel and the center of the front-right wheel, and WB is a wheel base of the vehicle, and determining the height of the vehicle center of gravity relative to the terrain may include evaluating

H_{T}=((W_{S})(H_{S}+R_{U})+(W_{U})(R_{U}))/(W_{T});

wherein H_{T} is the height of the vehicle center of gravity relative to the terrain, H_{S} is a height of the sprung portion center of gravity relative to a plane of the unsprung portion, said plane of the unsprung portion including wheel centers, and R_{U} is a height of the center of gravity of an unsprung portion.

For a better understanding of the present invention, together with other and further aspects thereof, reference is made to the accompanying drawings and detailed description and its scope will be pointed out in the appended claims.

### BRIEF DESCRIPTION OF THE DRAWINGS

For a better understanding of the present invention, reference is made to the figures, in which:

FIG. 1A is a cross-sectional side schematic illustration of a prior art vehicle having a sprung portion capable of being elevated relative to the centers of the wheels by adjustable supports;

FIG. 1B is a top view schematic illustration of a prior art vehicle having a sprung portion capable of being elevated relative to the centers of the wheels by adjustable supports;

FIG. 1C is a front view schematic illustration of a prior art vehicle having a sprung portion capable of being elevated relative to the centers of the wheels by adjustable supports;

FIG. 2 is a cross-sectional side schematic illustration of a vehicle having a sprung portion capable of being raised and containing a pressure sensor for each adjustable support, longitudinal and lateral tilt sensors, and a controller, according to an embodiment of the present invention;

FIG. 3 is a schematic illustration of a vehicle, according to an embodiment of the present invention, having a sprung portion capable of being raised and resting on a sloping terrain;

FIGS. 4A and 4B is a flowchart, according to an embodiment of the present invention, for a method for calculation of the location of the center of gravity of the vehicle;

FIG. 5A is a schematic illustration of a vehicle, according to an embodiment of the present invention, showing a side view of the vehicle on sloping terrain in an unraised condition;

FIG. 5B is a schematic illustration of a vehicle, according to an embodiment of the present invention, showing a side view of the vehicle on sloping terrain in a raised conditions where the rear is raised relative to the front;

FIG. 6A is a schematic illustration of a vehicle according to an embodiment of the present invention, showing a front view of the vehicle on sloping terrain in an unraised condition;

FIG. 6B is a schematic illustration of a vehicle, according to an embodiment of the present invention, showing a front view of the vehicle on sloping terrain in a raised condition where the left side of the vehicle (as viewed by an operator of the vehicle) is raised relative to the right side;

FIG. 7 is a flowchart for a method according to an embodiment of the present invention for calculation of the sprung portion center of gravity;

FIG. 8 is a flowchart for a method according to an embodiment of the present invention for calculation of the vehicle center of gravity, including the sprung and unsprung portions of the vehicle; and

FIG. 9 is a schematic illustration of vehicle, according to an embodiment of the present invention, having a sprung portion capable of being raised and resting on a sloping terrain, further illustrating a relationship between the center of gravity of the sprung portion and the vehicle center of gravity.

### DETAILED DESCRIPTION OF THE INVENTION

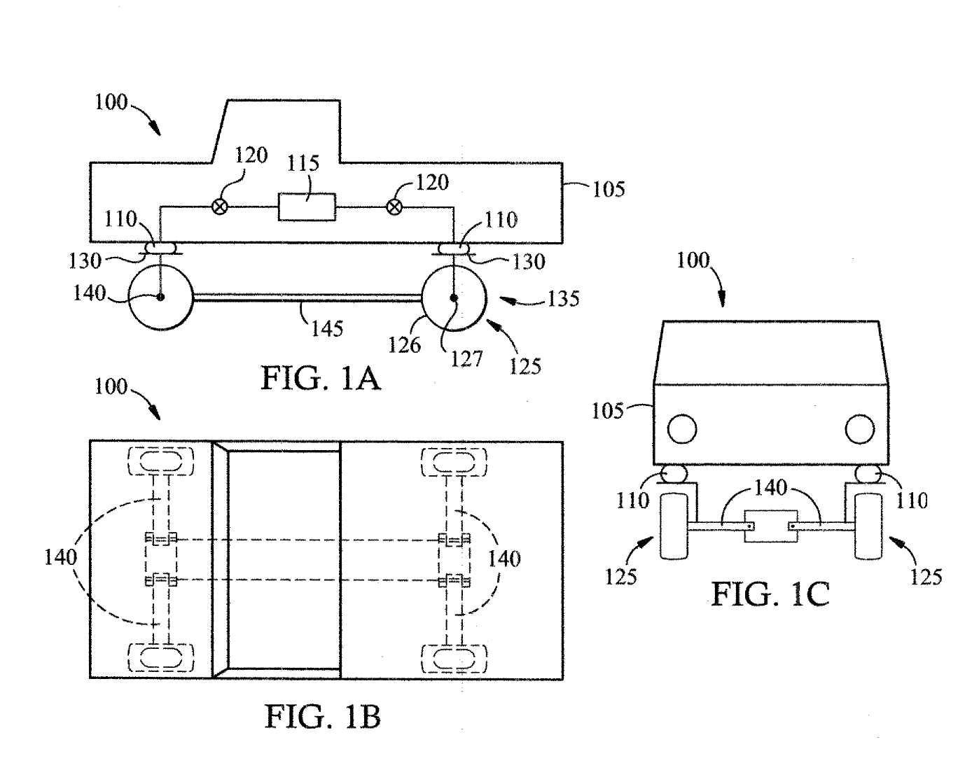

FIG. 1A includes a cross-sectional side view schematic illustration of a prior art vehicle 100 having the capability of raising its chassis 105 to varying amounts. FIG. 1B is the related top view schematic illustration of the prior art vehicle 100 and FIG. 1C is the related front view schematic illustration of the prior art vehicle 100. In addition to the adjustable supports 110 associated with each wheel 125 is a compressor 115 to furnish pressurized fluid such as air or hydraulic fluid and valves 120 to selectively allow inflation or deflation of the adjustable supports 110. Examples of adjustable supports 110 are air springs or air bags and hydraulic struts, which may take the place of springs.

Vehicles for use offroad benefit from an ability to raise he clearance between their chassis or cargo-carrying section and the ground, thereby becoming less endangered by high water levels or debris in their path. One means to gain this clearance is to mount an adjustable support 110 proximate to each wheel 125 and positioned between the chassis 105 and a support fixture 130 associated with each wheel 175. As the adjustable supports 110 are pressurized, the height of the chassis 105 increases to a variable and controllable degree. Deflation of the adjustable supports 110 results in a lowering of the chassis 105. The portion of the vehicle 100 raised by the adjustable supports 110 is the sprung portion or chassis 105, and that portion remaining in fixed height relation with the ground or terrain 150 is the unsprung portion 135. The unsprung portion 135 may include, for example, the wheels 125, including tires 126 and wheel ends 127, and a portion of the suspension components, such as support fixture 130, axles 140, and drive train 145, dependent upon the specific vehicle design in use.

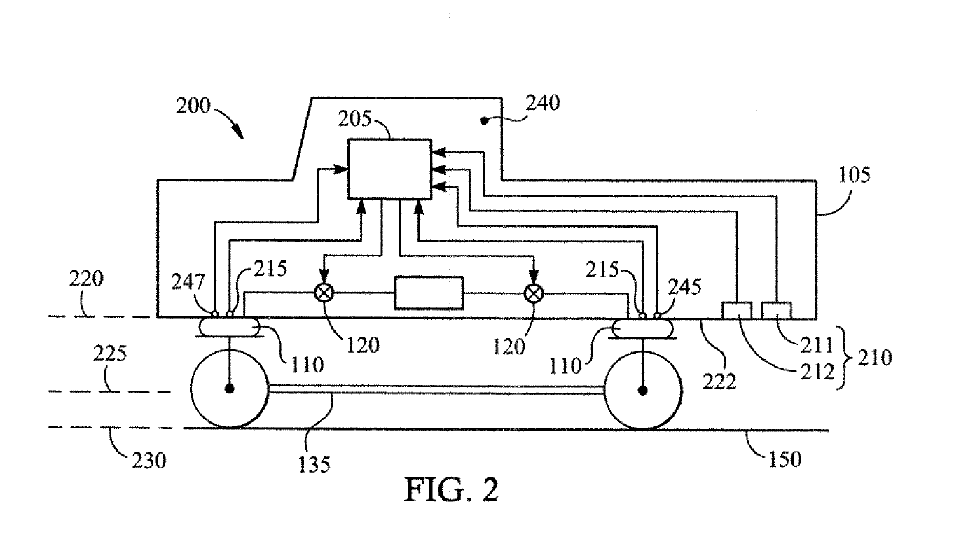

FIG. 2 is a cross-sectional plan view schematic illustration of a vehicle 200 according to an embodiment of the present invention. In addition to the adjustable support 110 for each wheel 125 and a valve 120 for each adjustable support 110, the vehicle includes a controller 205, tilt sensors 210O, and pressure sensors 215. A lateral tilt sensor 211 may provide the lateral tilt, for example, in the right-to-left direction, of a plane 220 of the sprung portion 105 in the form of a signal to a controller 205, and a longitudinal tilt sensor 212 may provide the longitudinal tilt, for example, in the front-to-rear direction, of the sprung portion 105 in the form of another signal to the controller 205. Of course, the lateral tilt sensor 211 may also provide the left-to-right tilt angle and the longitudinal tilt sensor 212 may also provide the rear-to-front tilt angle. The pressure sensor 215 coupled to each adjustable support 110 may provide the pressure within each adjustable support 110 to the controller 205. The controller 205, upon receiving tilt sensor 210 and adjustable support pressure sensor 215 signals, may determine the position of vehicle center of gravity 240, in a manner to be described.

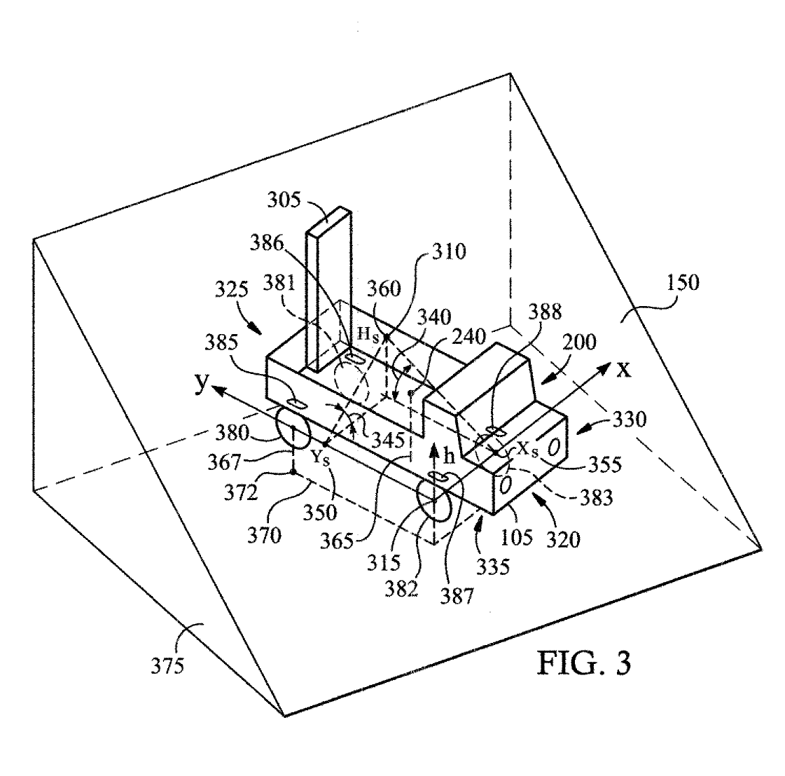

FIG. 3 is a schematic illustration of the vehicle 200, according to an embodiment of the present invention, resting on a sloping terrain 150. The distribution of a load 305 carried by the sprung portion 105 has much to do with the stability of the vehicle 200 during transit. There may be a need for arranging the load 305 to minimize the likelihood of the vehicle 200 rolling over. Although the distribution of the weight of the vehicle 200 without load 305 is determined at the time of manufacture, the overall stability of the vehicle 200, as influenced by both the vehicle 200 and its load 305, depends upon the positioning of the load 305.

The vehicle center of gravity 240 may be calculated for a distribution of the load 305 as shown in FIG. 3. If the center 315 of each wheel 125 is vertically projected onto a horizontal plane 375 lying beneath the vehicle 200, and if points of intersection 372 on the horizontal plane 375 are interconnected, the result is a perimeter 370 lying on the horizontal plane 375. If a vertical projection 365 of the vehicle center of gravity 240 onto the horizontal plane 375 falls within the perimeter 370 associated with the vertical projections 367 of the wheel centers 315 onto a horizontal plane 375, the vehicle 200 remains stable. However, if the vehicle center of gravity 240 falls beyond the perimeter 370, the vehicle 200 is liable to roll over.

The vehicle center of gravity 240 of the vehicle 200 without load 305 may be determined from data supplied by the vehicle manufacturer. However, the vehicle center of gravity 240 may change in the field in connection with loading of the vehicle 200. Often, such loading is done on sloping ground or terrain 150

In the embodiments according to the present invention shown in FIG. 2 and in FIG. 3, the vehicle 200 includes the sprung portion 105 and the unsprung portion 135. The unsprung portion 135 includes the part of the vehicle positioned on the ground 150. Examples of the components of the unsprung portion 135 include, but are not limited to, the wheels 125, including tires 126 and wheel ends 127, and a portion of the suspension components, such as support fixture 130, axles 140, and drive train 145, dependent upon the specific vehicle design in use. Proximate to each wheel 125 is a separately inflatable adjustable support 110.

The controller 205 monitors pressures within the adjustable supports 110 and controls the amount of air injected into or released from the adjustable supports 110. The controller 205 also monitors the sensors 210 measuring the tilt of the sprung portion, both longitudinally 212, with respect to the front 320 and rear 325 of the vehicle 200, and laterally 211, with respect to the left 330 and the right sides 335 of the vehicle 200, where left and right are as viewed from the rear 325 of the vehicle 200. Ordinarily, the adjustable supports 110 over each wheel 125 are inflated equally, resulting in the plane 220 of the sprung portion 105, substantially coinciding with a bottom 222 of the sprung portion 105, being parallel to the plane 225 of the unsprung portion 135, containing the centers 315 of the wheels 125, and to the plane 230 of the terrain 235 as presented in FIG. 2 and in FIG. 3. However, equal inflation is not considered a limitation to the invention since the adjustable supports 110 may be inflated unequally as well.

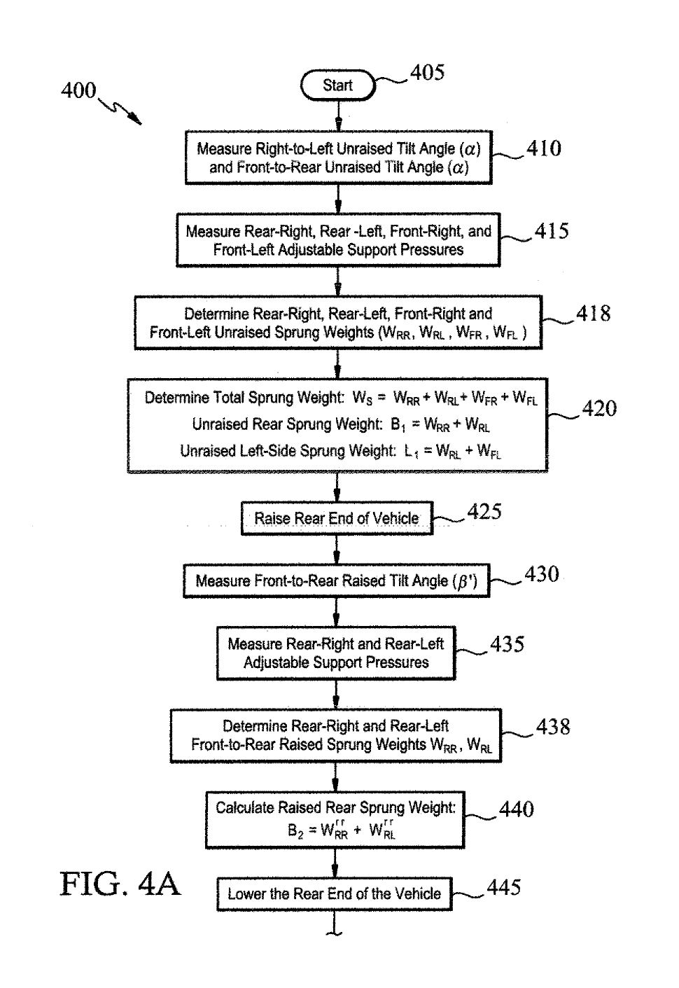

FIG. 4 contains a flowchart for a method 400 according to an embodiment of the present invention for determining the vehicle center of gravity 240 when the vehicle 200 carrying load 305 resides on sloping terrain 150. The position of the vehicle center of gravity 240 is related to the results of measurements performed when the vehicle 200 is in three orientations—the sprung portion 105 parallel to the terrain 150, the sprung portion 105 deliberately tilted front-to-rear relative to the terrain 150, and the sprung portion 105 deliberately tilted left-to-right relative to the terrain 150. For each orientation, measurements of the angle of the plane 220 of the sprung portion 105 relative to the horizontal plane 375 are taken, as well as measurements of the pressures in the adjustable supports 110 supporting the sprung portion 105 above each wheel 125. From the pressure measurements and from the areas of the adjustable supports 110 elevating the sprung portion 105 above each wheel 125, the weights carried by each adjustable support 110 is determined. As the orientation of the vehicle 200 is changed, the weights carried by the adjustable supports 110 change also as weight shifts away from the elevated adjustable supports 110 to the depressed adjustable supports 110. From the measured angles and the shifting weights, the location of the vehicle center of gravity is determined. Although the plane 220 of the sprung portion 105 is taken to be initially parallel to the plane 225 of the unsprung portion 135 and to the plane 230 of the terrain 150, this need not be the case and equations may be adjusted to reflect a non-parallel initial relationship between the plane 220 of the sprung portion 105 and the plane 225 of the unsprung portion 135 and the plane 230 of the terrain 150. In practice, determination of the center of gravity 240 of the vehicle 200 using the method 400 may take between 5 and 15 seconds.

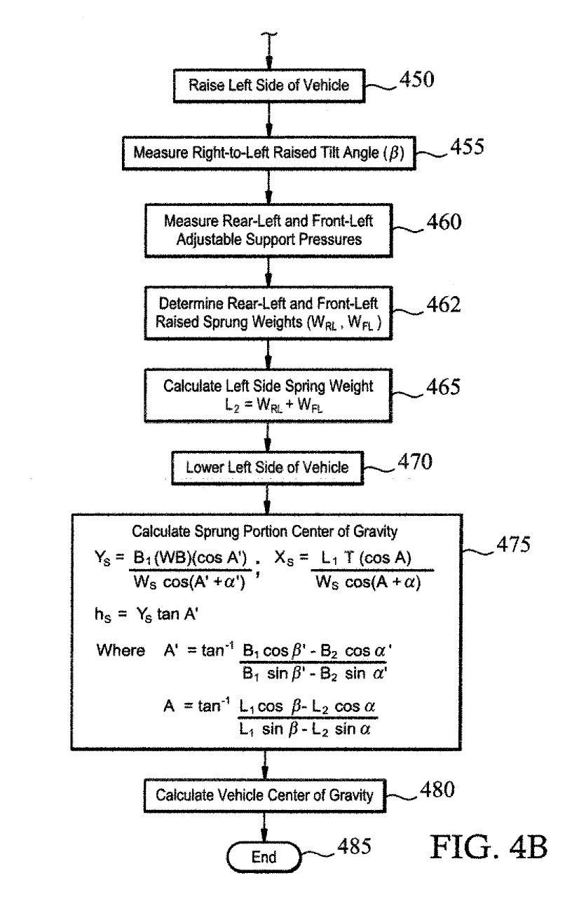

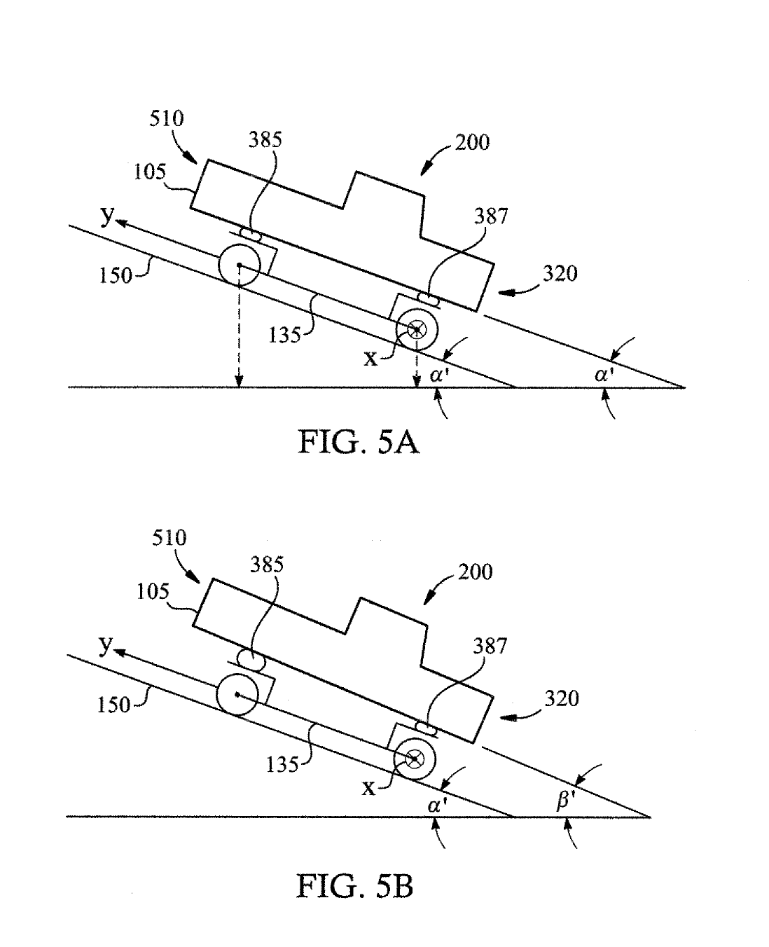

Initially, the longitudinal tilt and lateral tilt of the terrain 150 and the adjustable support pressures for the sprung portion 105 in an unraised position, that is, where the sprung portion 105 is parallel to the unsprung portion 135 and to the terrain 150, are measured. However, the sprung portion 105 need not he originally parallel to the unsprung portion. In step 410, the right-to-left unraised tilt angle 605 (α), corresponding to an unraised lateral tilt angle, and the front-to-rear unraised tilt angle 505 (α′), corresponding to an unraised longitudinal tilt angle, both arising from the tilt of the terrain 150 as shown in FIG. 5A and FIG. 6A, are measured.

In step 418, the weights W carried by each of the adjustable supports 110 when the vehicle 200 is in an unraised position is determined from a measurement of the pressure within the adjustable supports 110 and from the area of the adjustable support 110 supporting the sprung portion 105 at that point. Pressure relates directly to the force exerted by the adjustable supports 110. The relationship between pressure within the adjustable support 110 and the force exerted by the adjustable support 110 on the sprung portion 105 may be supplied by the manufacturer of the adjustable support 110. The rear-right unraised or terrain-induced sprung weight over the rear right wheel 380 (W_{RRU}), the rear-left unraised or terrain-induced sprung weight over the rear left wheel 381 (W_{RLU}), the front-right unraised or terrain-induced sprung weight over the front right wheel 382 (W_{FRU}), and front-left unraised or terrain-induced sprung weight over the front left wheel 383 (W_{FLU}) unraised or terrain-induced sprung weights are determined from measurements of the pressures in the rear-right 385, rear-left 386, front-right 387, and front-left 388 adjustable supports in step 415.

In step 420, the total sprung weight W_{S}(=W_{RRU}+W_{RLU}+W_{FRU}+W_{FLU}), the unraised rear sprung weight B₁(=W_{RRU}+W_{RLU}), corresponding to an unraised longitudinal sprung weight, and the unraised left side sprung weight L₁(=W_{RLU}+W_{FLU}), corresponding to an unraised lateral sprung weight, are determined, with the suspension geometry taken into account. In each case, it is assumed that the sprung weights act through the center points 315 of the particular wheels 125.

Since all calculations are based on dimensions assessed from the centers of the wheels, the specific geometries of the actual suspension in use must be taken into consideration. The moment arm from the adjustable support 110, that is, air bag, mounting point to the wheel center 315 would be an element of the calculations used in determining individual sprung weights over individual wheels 125 in the situations where the sprung weights do not act through the center points 315 of the particular wheels 125.

In step 425, the vehicle 200 is raised longitudinally, that is, the rear end 325 of the vehicle 200 is elevated. FIG. 5A and FIG. 5B are schematic illustrations of the vehicle 200 shown on sloping terrain 150 in FIG. 3. FIG. 5A and FIG. 5B include side views of the vehicle 200 according to an embodiment of the present invention and illustrate adjustable support inflation or expansion resulting in a front-to-back tilt of the vehicle 200. Adjustable support pressure sensors 215 and the front-to-back tilt sensor 212 provide the controller 205 with signals indicative of the pressures within the adjustable supports 110 and the tilt of the sprung portion 105.

In FIG. 5A, the sprung portion 105 is parallel to the unsprung portion 135 and to the ground or terrain 150 having a slope α′. When the rear-right adjustable support 385 and the rear-left adjustable support 386 (FIG. 3) are further inflated, the sprung portion 105 is given an additional tilt from the front to the rear of the vehicle 200. It is also possible to maintain the pressure in the rear-right 385 and rear-left 386 adjustable supports and to additionally inflate the front-right adjustable support 387 and the front-left adjustable support 388 (FIG. 3). The greater the tilt provided by inflation of the adjustable supports 110, the more accurate is measurement of the tilt by tilt sensor 210 (FIG. 2). In fact, theoretically, any change in tilt, no matter how small, may be adequate. The example and the subsequent equations reflect the vehicle 100 pointing down a slope. The equations may be modified in a straightforward manner to accommodate the vehicle 100 pointing up a slope.

As shown in FIG. 5B, a longitudinal side of the sprung portion, in this case, the rear end or rear side 510 is raised by further expanding the rear-left 386 and rear-right 385 adjustable supports (FIG. 3). A raised longitudinal tilt angle, in this case the raised front-to-rear tilt angle β′, is measured in step 430 and the rear-right and rear-left adjustable support pressures are measured in step 435 and used to determine the raised rear-right and raised rear-left raised sprung weights (W_{RRR} and W_{RLR}). In step 40, a raised longitudinal sprung weight, in this case, the raised rear sprung weight B₂(=W_{RRR}+W_{RLR}), is determined. Once the controller 205 captures the measurements, the rear-left adjustable support 386 and the rear-right adjustable support 385 are deflated, and the rear side 510 of the sprung portion 105 returns to an unraised position.

After the rear side 510 of the sprung portion 105 is lowered so that the sprung portion 105 once again is parallel to the unsprung portion 135 and to he terrain 150 (step 445), the sprung portion 105 is raised laterally (step 450). FIG. 6A and FIG. 6B are schematic illustrations of the vehicle 200 shown on sloping terrain 150 in FIG. 3, from the point of view of the front 320 of the vehicle 200. In embodiments according to the present invention, the adjustable supports 110 are inflated differentially to cause an addition to the tilt of the vehicle 200 beyond the tilt provided by the terrain 150.

In FIG. 6A, the sprung portion 105 is parallel to the unsprung portion 135 and to the ground or terrain 150. When the front-left adjustable support 388 and the rear-left 386 adjustable support are further inflated, the sprung portion 105 is given an additional tilt from the right side to the left side. Of course, it is also possible to maintain the pressure in the rear-left 386 and front-left adjustable supports 388 and to additionally inflate the front-right adjustable support 387 and the rear-right adjustable support 385.

As shown in FIG. 6B, a lateral side, in this case, the left side 330 of the sprung portion 105, is raised relative to the right side 335 of the sprung portion 105 by initiating a front-left wheel adjustable support 388 and a rear-left adjustable support 386. Once the left side 330 of the sprung portion 105 is raised, a raised lateral tilt angle, in this case, the right-to-left raised tilt angle 610 (β), is measured in step 455 and the rear-left and front-left adjustable support pressures are measured in step 460 and used to determine the raised rear-left and raised front-left sprung weights (W_{RLR} and W_{FLR}) in step 462. In step 465, the raised lateral sprung weight, in this case, the left-side sprung weight L₂(×W_{RLR}+W_{FLR}), is calculated. In step 470, the left-side 330 of the sprung portion 105 is lowered so that the sprung portion 105 is parallel to the unsprung portion 135 and the underlying terrain 150.

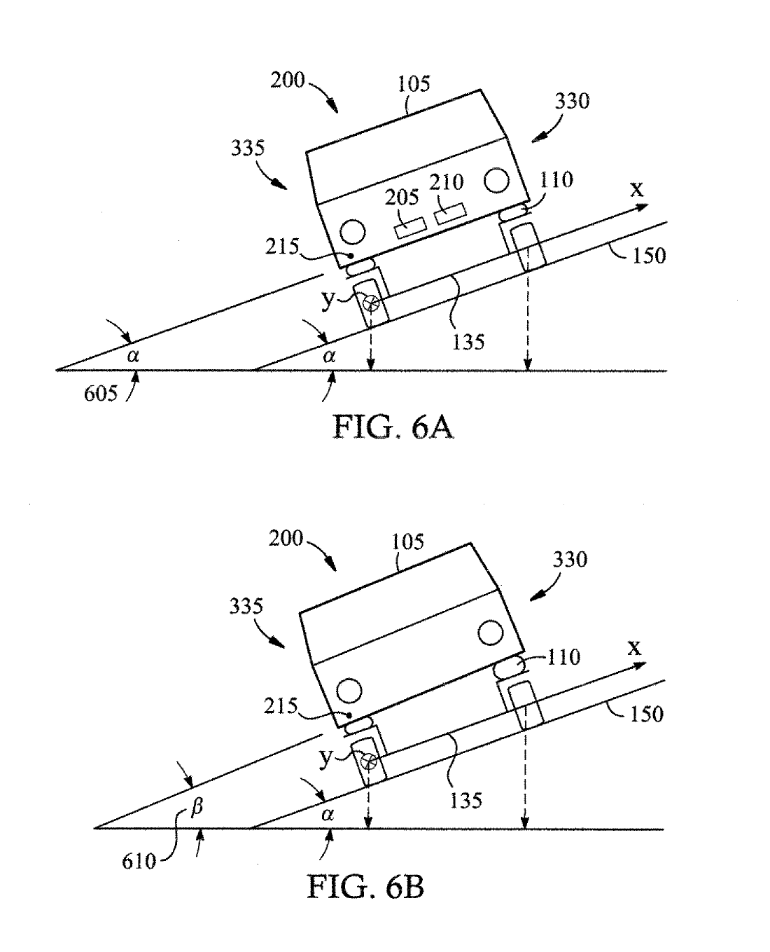

The sprung portion center of gravity 310 is determined in step 475. (Step 475 addresses the complete calculation of the sprung portion center of gravity, shown in detail in FIG. 7.) FIG. 7 includes a flowchart of a method according to an embodiment of the present invention for determining the sprung portion center of gravity 310. A longitudinal angle of the center of gravity of the sprung portion 105 with respect to the front axle 140 or a line between the centers 315 of the front-right wheel 382 and front-left wheel 383, A′ 340, as shown in FIG. 3, is determined in step 710 as:

A′=tan⁻¹(((B₁)(cos β′)−(B₂)(cos α′))/((B₁)(sin β′)−(B₂)(sin α′))).

(Step 475 of FIG. 4 includes all the steps of FIG. 7.)

A lateral angle of the center of gravity of the sprung portion 310 with respect to a line connecting the centers 315 of the front-right wheel 382 and the rear-right wheel 380, A 345, as shown in FIG. 3 is determined in step 725 as:

A=tan⁻¹(((L₁)(cos β)−(L₂)(cos α))/((L₁)(sin β)−(L₂)(sin α))).

A longitudinal position of the center of gravity of the sprung portion 310 relative to the front axle 140 of the vehicle 200 or a line between the centers 315 of the front-right 382 and front-left 383 wheels, Y_{S} 350, is determined in step 715 as:

Y_{S}=((B₁)(WB)(cos A′))/((W_{S})(cos (A′+α′)));

where WB is the wheelbase of the vehicle 200, that is, the distance or separation between the centers 315 of the front-right wheel 382 and the rear-right wheel 381.

The lateral position of the center of gravity of the sprung portion 310 relative to a line between the centers 315 of the front-right wheel 382 and the rear-right wheel 380, X_{S} 355, is determined in step 730 as:

X_{S}=((L₁)(T)(cos A))/((W_{S})(cos(A+α)));

where T is the track of the vehicle, that is, the separation between the centers of the front-right wheel 382 and the front-left wheel 383. The calculation assumes that T is also the separation between the centers of the rear-right wheel 380 and the rear-left wheel 381, that is, that there is even track width front and rear. If the separation between the front wheel centers differs from the separation between the rear wheel centers, that difference needs to be taken into account in the calculation. In determining X_{S} 355, the effects of the particular suspension in use is to he taken into consideration. In certain suspension designs, for example, independent suspensions, the track width T may change as the suspension goes through its range of travel. The effects of the roll center of the vehicle and the potential change in track width (T) as a function of suspension travel are to be accounted for.

The height of the sprung portion center of gravity 310 above the plane containing the wheel centers 315, that is, the plane of the unsprung portion 225 (FIG. 2), is calculated in step 720 as:

H_{S}=(Y_{S})(tan A′)

For the other orientations, for example, raising the right side 335 instead of the left side 330 or raising the front 320 rather that the rear 325, alternative versions of the above equations apply.

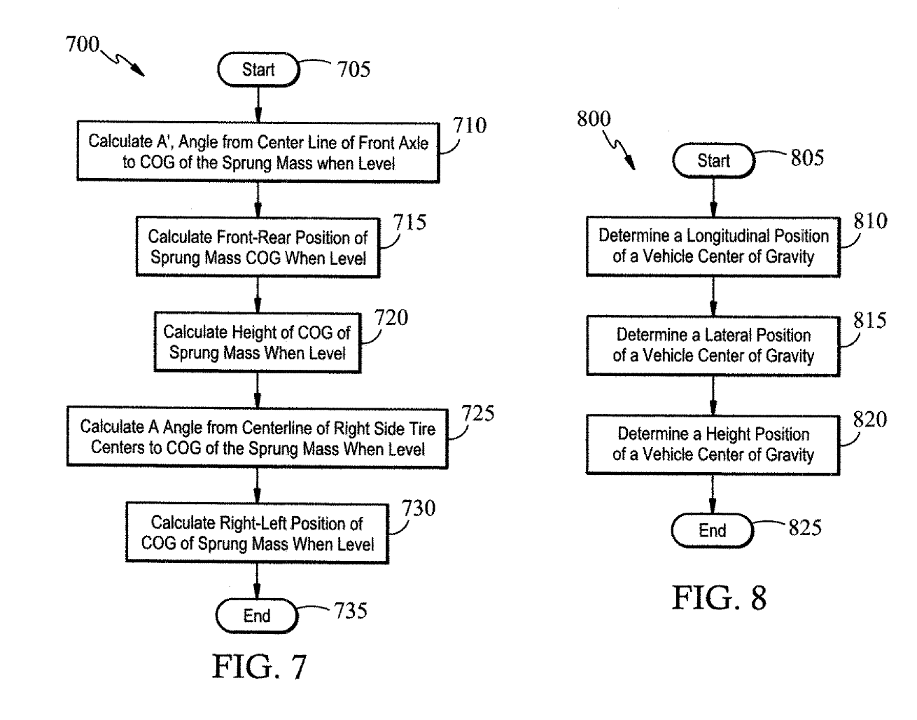

FIG. 8 contains flow chart of a method according to an embodiment of the present invention for determining the location of the vehicle center-of-gravity 315, including both the sprung 105 and the unsprung 135 portions, W_{U} is the weight of the unsprung portion 135. R_{U} is the height of the center of gravity of the unsprung portion 135, taken to be at the wheel centers 315. Both W_{U} and R_{U} are manufacturer's constants.

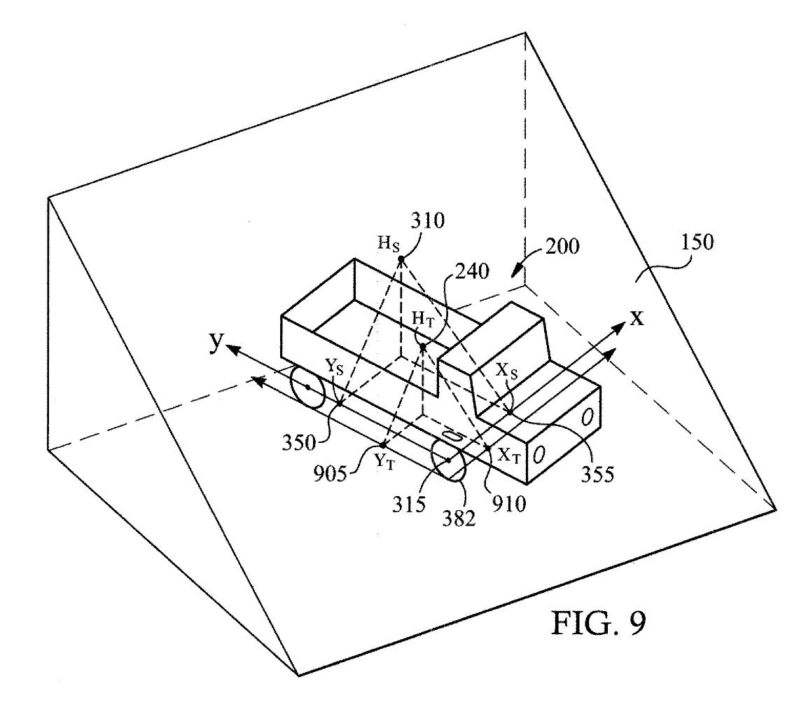

Y_{T} 905 (FIG. 9) is the longitudinal location of the vehicle center of gravity 240 relative to the center 915 of the front-right wheel 382, determined in step 810 as:

Y_{T}=((W_{S})(Y_{S})+(W_{U})(WB/2))/(W_{T}).

X_{T} 910 is the lateral location of the vehicle center-of-gravity 315 relative to the center 915 of the front-right wheel 382, determined in step 815 as:

X_{T}=((W_{S})(X_{S})+(W_{U})(T/2))/(W_{T}).

H_{T} 915 is the height of the vehicle center of gravity 240 above the terrain 150, determined in step 820 as:

H_{T}=((W_{S})(H_{S}+R_{U})+(W_{U})(R_{U}))/(W_{T}).

The vehicle weight or total weight W_{T} may be determined as:

W_{T}=W_{S}+W_{U}.

Although the preceding discussion was directed to measurement of the center of gravity 240 on uneven terrain, measurement of the center of gravity is also achievable on level terrain, that is, when the right-to-left unraised tilt angle α and front-to-rear unraised tilt angle α′ are substantially zero. In this case, the right-to-left raised tilt angle β and the front-to-rear raised tilt angle β may also be determined by the tilt sensor 210. However, the right-to-left raised tilt angle β and the front-to-rear raised tilt angle β may be also be determined by ride height sensors (rear-right 245, rear-left 246, front-right 247, and front-left 248), placed on the rear-right 385, rear-left 381, front-right 387, and front-left 388 adjustable supports and generating signals indicative of the separation between the rear-right 385, rear-left 386, front-right 387, and front-left 388 adjustable supports and the chassis 105 above the center 315 of each wheel 125.

The front-to-rear raised tilt angle β may be the difference in height between the chassis 105 raised above the rear-left adjustable support 381 and the chassis above the front-left adjustable support 388 divided by the wheel base WB or the difference in height between the chassis 105 raised above the rear-right adjustable support 385 and the chassis 105 above the front-right adjustable support 387 divided by the wheel base WB.

The right-to-left raised tilt angle β may be the difference in height between the chassis 105 raised above the front-left adjustable support 388 and the chassis 105 above the front-right adjustable support 387 or the difference in height between the chassis 105 raised above the rear-right support 385 and the chassis 105 above the rear-left adjustable support 386 divided by the track width T.

With information from the manufacturer, the right-to-left raised tilt angle β and the front-to-rear raised tilt angle β may be obtained without a tilt sensor 210 or a height sensors 245, 246, 247, and 248. If the difference in heights of the adjustable supports 110 driven to two predetermined settings, e.g. at minimum inflation and at maximum inflation, is known, then the right-to-left raised tilt angle β may be determined as the difference in height between the chassis 105 raised above the front-left adjustable support 388 and the chassis 105 above the front-right adjustable support 387 divided by the track width T or the difference in height between the chassis 105 raised above the rear-left adjustable support 386 and the chassis 105 above the rear-right adjustable support 385 divided by the track width T.

The front-to-rear raised tilt angle β may be determined as the difference in height between the chassis 105 raised above the rear-left adjustable support 386 and the chassis 105 above the front-left adjustable support 388 divided by the wheelbase WB or the difference in height between the chassis 105 raised above the rear-right adjustable support 385 and the chassis 105 above the front-right adjustable support 387 divided by the wheelbase WB.

Although the invention has been described with respect to various embodiments, it should be realized that this invention is also capable of a wide variety of further and other embodiments within the spirit and the scope of the appended claims.

What is claimed is:

1. A method for determining a center of gravity of a vehicle having a sprung portion and an unsprung portion, the method comprising:
determining at least one unraised tilt angle by determining an unraised longitudinal tilt angle and an unraised lateral tilt angle;
determining at least one unraised sprung weight by determining an unraised longitudinal sprung weight and an unraised lateral sprung weight;
raising a side of the sprung portion;
determining a raised tilt angle;
determining a raised sprung weight;
lowering the side of the sprung portion;
raising another side of the sprung portion;
determining another raised tilt angle;
determining another raised sprung weight;
lowering the other side of the vehicle;
determining a sprung portion center of gravity position; and
determining the vehicle center of gravity position based upon the above determinations.

2. The method of claim 1, wherein determining an unraised longitudinal tilt angle comprises determining a terrain-induced front-to-back tilt angle; and
wherein determining an unraised lateral tilt angle comprises determining a terrain-induced right-to-left tilt angle.

3. The method of claim 17 wherein determining an unraised longitudinal sprung weight and an unraised lateral sprung weight comprises;
determining a terrain-induced sprung weight over a rear-left wheel;
determining a terrain-induced sprung weight over a rear-right wheel;
determining the unraised longitudinal sprung weight by summing the terrain-induced sprung weight over a rear-left wheel and the terrain-induced sprung weight over a rear-right wheel;
determining a terrain-induced sprung weight over a front-left wheel; and
determining the unraised lateral sprung weight by summing the terrain-induced sprung weight over a front-left wheel and the terrain-induced sprung weight over a rear-left wheel.

4. The method of claim 1, wherein raising a side of the sprung portion comprises raising a longitudinal side of the sprung portion; and
wherein determining a raised tilt angle comprises determining a raised longitudinal tilt angle.

5. The method of claim 4, wherein raising a longitudinal side of the sprung portion comprises:
expanding a rear-left wheel adjustable support and a rear-right adjustable support.

6. The method of claim 4, wherein determining a raised longitudinal tilt angle comprises:
measuring a raised front-to-rear tilt angle.

7. The method of claim 4, wherein determining a raised longitudinal tilt angle comprises:
determining a height of an adjustable support, the adjustable support being at a lateral position;
determining a height of another adjustable support, the other adjustable support being at the lateral position; and
determining the raised longitudinal tilt angle as a difference between the height of the adjustable support and the height of the other adjustable support divided by a wheel base of the vehicle.

8. The method of claim 7, wherein the adjustable support is at a maximum expansion and the other adjustable support is at a minimum expansion.

9. The method of claim 4, wherein determining a raised sprung weight comprises:
determining a raised longitudinal sprung weight.

10. The method of claim 9, wherein determining a raised sprung weight comprises:
determining a raised-sprung weight over a rear-left wheel;
determining a raised-sprung weight over a rear-right wheel; and
determining the longitudinal raised sprung weight as the sum of the raised-sprung weight over the rear-left wheel and the raised-sprung weight over the rear-right wheel.

11. The method of claim 1, wherein raising another side of the vehicle comprises raising a lateral side of the vehicle; and
wherein determining another raised tilt angle comprises determining a raised lateral tilt angle.

12. The method of claim 11, wherein raising the lateral side of the vehicle comprises:
expanding a front-left wheel adjustable support and a rear left-wheel adjustable support.

13. The method of claim 11, wherein determining a raised lateral tilt angle comprises:
measuring a raised left-to-right tilt angle.

14. The method of claim 11, wherein determining a raised lateral tilt angle comprises:
determining a height of an adjustable support, the adjustable support being at a longitudinal position;
determining a height of another adjustable support, the other front adjustable support being at the longitudinal position ; and
determining the raised lateral tilt angle as a difference between the height of the adjustable support and the height of the other adjustable support divided by a wheel base of the vehicle.

15. The method of claim 14, wherein the adjustable support is at a maximum expansion and the other adjustable support is at a minimum expansion.

16. The method of claim 11, wherein determining another raised sprung weight comprises:
determining a raised lateral sprung weight.

17. The method of claim 16, wherein determining a raised lateral sprung weight comprises:
determining a raised-sprung weight over a front-left wheel;
determining a raised-sprung weight over a rear-left wheel; and
determining the raised lateral sprung weight as the sum of the raised-sprung weight over the front-left wheel and the raised-sprung weight over the rear-left wheel.

18. The method of claim 1, wherein determining a sprung portion center of gravity position comprises:
determining a lateral angle of a sprung portion center of gravity relative to a line connecting a center of a front-right wheel and a center of a rear-right wheel;
determining a lateral position of the sprung portion center of gravity relative to the line connecting the center of the front-right wheel and the center of the rear-right wheel;
determining a longitudinal angle of the sprung portion center of gravity perpendicular to the line connecting the center of a front-left wheel and center of the front-right wheel;
determining a longitudinal position of the sprung portion center of gravity perpendicular to the line connecting the center of the front-left wheel and the center of the front-right wheel; and
determining a height of the sprung portion center of gravity relative to the sprung portion.

19. The method of claim 18, wherein determining a longitudinal angle of a sprung portion center of gravity perpendicular to the line connecting the center of the front-left wheel and center of the front-right wheel includes evaluating
A′=tan⁻¹(((B₁)(cos β′)−(B₂)(cos α′))/((B₁)(sin β′)−(B₂)(sin α′)));
wherein A′ is the longitudinal angle of the sprung portion center of gravity, B₁ is an unraised longitudinal sprung weight, B₂ is a raised longitudinal sprung weight, α′ is an unraised longitudinal tilt angle, and β′ is a raised longitudinal tilt angle;
wherein determining a longitudinal position of the sprung portion center of gravity perpendicular to the line connecting the center of the front-left wheel and the center of the front-right wheel includes evaluating
Y_{S}=((B₁)(WB)(cos A′))/((W_{S})(cos (A′+60 ′)));
wherein Y_{S} is the longitudinal position of the sprung portion center of gravity perpendicular to the line connecting the center of the front-left wheel and the center of the front-right wheel, WB is the wheelbase of the vehicle, and W_{S} is the sprung weight of the vehicle;
wherein determining the height of the sprung portion center of gravity relative to the unsprung portion includes evaluating
H_{S}=(Y_{S})(tan A′);
wherein H_{S} is the height of the sprung portion center of gravity relative to a plane of the unsprung portion, said plane of the unsprung portion including wheel centers;
wherein determining a lateral angle of a sprung portion center of gravity relative to a line connecting a center of the front-right wheel and a center of the rear-right wheel includes evaluating
A=tan⁻¹(((L₁)(cos β)−(L₂)(cos α))/((L₁)(sin β)−(L₂)(sin α)));
wherein A is a lateral angle of the sprung portion center of gravity relative to a line connecting a center of the front-right wheel and a center of the rear-right wheel L₁ is an unraised lateral sprung weight, L₂ is an raised lateral sprung weight, α is an unraised lateral tilt angle, and β is a raised lateral tilt angle; and
wherein determining a lateral position of the sprung portion center of gravity relative to the line connecting the center of the front-right wheel and the center of the rear-right wheel includes evaluating
X_{S}=((L₁)(T)(cos A))/((W_{S})(cos(A+α)));
wherein X_{S} is the lateral position of the sprung portion center of gravity relative to the line connecting the center of the front-right wheel and the center of the rear-right wheel, T is the track width of the vehicle, and W_{S} is the sprung weight of the vehicle.

20. The method of claim 1, wherein determining the vehicle center of gravity position comprises:
determining a lateral position of the vehicle center of gravity relative to the line connecting the center of a front-right wheel and the center of a rear-right wheel;
determining a longitudinal position of the vehicle center of gravity perpendicular to the line connecting the center of a front-left wheel and the center of the front-right wheel; and
determining a height of the vehicle center of gravity relative to a terrain.

21. The method of claim 27, wherein determining a lateral position of the vehicle center of gravity relative to the line connecting the center of the front-right wheel and the center of the rear-right wheel includes evaluating
X_{T}((W_{S})(X_{S})+(W_{U})(T/2))/(W_{T});
wherein X_{T} is the lateral position of the vehicle center of gravity relative to the line connecting the center of the front-right wheel and the center of the rear-right wheel, W_{S} is a total sprung weight, X_{S} is a lateral position of the sprung portion center of gravity relative to the line connecting the center of the front-right wheel and the center of the rear-right wheel, W_{U} is a weight of the unsprung portion, T is a track width, and W_{T} is the total weight of the vehicle, the sum of W_{S} and W_{U};
wherein determining a longitudinal position of the vehicle center of gravity perpendicular to the line connecting the center of the front-left wheel and the center of the front-right wheel includes evaluating
Y_{T}=((W_{S})(Y_{S})+(W_{U})(WB/2))/(W_{T});
wherein Y_{T} is the longitudinal position of the vehicle center of gravity perpendicular to the line connecting the center of the front-left wheel and the center of the front-right wheel, Y_{S} is a longitudinal position of the sprung portion center of gravity relative to the line connecting the center of the front-left wheel and the center of the front-right wheel, and WB is a wheel base of the vehicle; and
wherein determining the height of the vehicle center of gravity relative to the terrain includes evaluating
H_{T}=((W_{S})(H_{S}+R_{U})+(W_{U})(R_{U}))/(W_{T});
wherein H_{T} is the height of the vehicle center of gravity relative to the terrain, H_{S} is a height of the sprung portion center of gravity relative to a plane of the unsprung portion, said plane of the unsprung portion including wheel centers, and R_{U} is a height of the center of gravity of an unsprung portion
